(19) United States
(12) Patent Application Publication
(10) Pub. No.: US 2022/0028579 A1
(43) Pub. Date: Jan. 27, 2022

(54) COMPOSITE CABLE

(71) Applicants: SUMITOMO WIRING SYSTEMS, LTD., Mie-ken (JP); SUMITOMO ELECTRIC INDUSTRIES, LTD., Osaka (JP)

(72) Inventors: Kenta KOBAYASHI, Yokkaichi-shi (JP); Jo YAGISAWA, Kanuma-shi (JP); Masayuki ISHIKAWA, Kanuma-shi (JP); Takumi OOSHIMA, Kanuma-shi (JP)

(21) Appl. No.: 17/296,982

(22) PCT Filed: Nov. 28, 2019
(86) PCT No.: PCT/JP2019/046478

§ 371 Date: May 26, 2021

(51) Int. Cl. H01B 7/18; B60R 16/02; H01B 7/00; H01B 11/02; H01B 7/22

(52) U.S. Cl. CPC H01B 7/1895; B60R 16/0215; H01B 7/225; H01B 11/02; H01B 7/0045

(57) ABSTRACT

A composite cable includes a wire bundle and an outer layer sheath that covers the wire bundle. The wire bundle includes single-core first and second electric wires, a double-core twisted pair electric wire, and first, second, and third wire-shaped fillers. In a cross-sectional view, the wire bundle includes a wire unit in which the first and second wires and the twisted pair wire are arranged in contact with one another. In an imaginary circumscribed circle circumscribing the wire unit, the first wire-shaped filler is disposed in a first space between the first wire, the second wire, and the imaginary circumscribed circle, the second wire-shaped filler is disposed in a second space between the second wire, the twisted pair wire, and the imaginary circumscribed circle, and the third wire-shaped filler is disposed in a third space between the twisted pair wire, the first wire, and the imaginary circumscribed circle.

### TECHNICAL FIELD

The present disclosure relates to a composite cable.

### BACKGROUND ART

In the field of vehicles such as automobiles, a typical composite cable has a multicore structure in which a sheath entirely covers the circumference of electric wires.

Patent Document 1 discloses a composite cable that includes an electric brake cable, an anti-lock braking system (ABS) sensor cable, and an external sheath. The electric brake cable includes two power wires. The ABS sensor cable includes two signal wires. The external sheath entirely covers the electric brake cable and the ABS sensor cable. Further, Patent Document 1 describes that other insulated electric wires such as a wire breakage detection wire can be integrated in addition to the electric brake cable and the ABS sensor cable in the composite cable.

### PRIOR ART LITERATURE

### Patent Document

Patent Document 1: Japanese Laid-Open Patent Publication No. 2013-237428

### SUMMARY OF THE INVENTION

### Problems that the Invention is to Solve

In the composite cable, electric wires are combined to form a wire bundle. Accordingly, even when a tape member or the like is wound around the surface of the wire bundle, the cross section of the wire bundle is not likely to be circular. In this case, rigidity is unevenly distributed in the circumferential direction of the composite cable. When the cable is repetitively bent such that the bending is concentrated in a direction in which the rigidity is relatively low, conductors will easily break.

Further, in the field of vehicles such as automobiles, a bracket including a crimp may be attached to the vehicle body to crimp and fasten a composite cable with the crimp of the bracket. In this case, the applied fastening force may be uneven due to the difficulty in maintaining the cable shape of the conventional composite cable.

In this respect, the objective of the present disclosure is to provide a composite cable that easily reduces concentrated bending in a certain direction when the cable is repetitively bent and easily stabilizes the fastening force when the cable is crimped by a bracket.

### Means for Solving the Problems

In an aspect of the present disclosure, a composite cable includes a wire bundle and an outer layer sheath that covers the wire bundle, in which:

the wire bundle includes a single-core first electric wire, a single-core second electric wire, a double-core twisted pair electric wire, a first wire-shaped filler formed to be wire-shaped, a second wire-shaped filler formed to be wire-shaped, and a third wire-shaped filler formed to be wire-shaped,

in a cross-sectional view, the wire bundle includes a wire unit in which the first electric wire, the second electric wire, and the twisted pair electric wire are arranged in contact with one another,

in an imaginary circumscribed circle circumscribing the wire unit,

the first wire-shaped filler is disposed in a first space between the first electric wire, the second electric wire, and the imaginary circumscribed circle,

the second wire-shaped filler is disposed in a second space between the second electric wire, the twisted pair electric wire, and the imaginary circumscribed circle, and

the third wire-shaped filler is disposed in a third space between the twisted pair electric wire, the first electric wire, and the imaginary circumscribed circle.

### Effects of the Invention

The above-described composite cable reduces concentrated bending in a certain direction when the cable is repetitively bent and stabilizes the fastening force when the cable is crimped by a bracket.

### BRIEF DESCRIPTION OF THE DRAWINGS

FIG. 1 is a schematic diagram showing the cross section of a composite cable in accordance with a first embodiment.

FIG. 2 is a schematic diagram illustrating an application example of the composite cable in accordance with the first embodiment.

FIG. 3 is a schematic diagram showing the cross section of a composite cable in accordance with a second embodiment.

### MODES FOR CARRYING OUT THE INVENTION

Description of Embodiment of Present Disclosure

An embodiment of the present disclosure will now be described.

A composite cable of the present disclosure includes

a wire bundle and an outer layer sheath that covers the wire bundle, in which:

the wire bundle includes a single-core first electric wire, a single-core second electric wire, a double-core twisted pair electric wire, a first wire-shaped filler formed to be wire-shaped, a second wire-shaped filler formed to be wire-shaped, and a third wire-shaped filler formed to be wire-shaped,

in a cross-sectional view, the wire bundle includes a wire unit in which the first electric wire, the second electric wire, and the twisted pair electric wire are arranged in contact with one another,

in an imaginary circumscribed circle circumscribing the wire unit,

the first wire-shaped filler is disposed in a first space between the first electric wire, the second electric wire, and the imaginary circumscribed circle,

the second wire-shaped filler is disposed in a second space between the second electric wire, the twisted pair electric wire, and the imaginary circumscribed circle, and

the third wire-shaped filler is disposed in a third space between the twisted pair electric wire, the first electric wire, and the imaginary circumscribed circle.

The composite cable of the present disclosure has the above-described structure. Accordingly, the composite cable of the present disclosure evenly distributes rigidity in the circumferential direction of the cable as compared to a composite cable that has a wire bundle including the first electric wire, the second electric wire, and the twisted pair electric wire but not a wire-shaped filler. This reduces situations in which the cable bends only in a certain direction. Therefore, the composite cable of the present disclosure reduces concentrated bending in a direction in which the rigidity is relatively low when the cable is repetitively bent and easily avoids wire breakage of the conductors.

Further, even when the composite cable of the present disclosure is fastened by a crimp of a bracket, the cable shape will be maintained as the first wire-shaped filler, the second wire-shaped filler, and the third wire-shaped filler deform in the first space, the second space, and the third space, respectively. Thus, the composite cable of the present disclosure readily maintains the cable shape and stabilizes the fastening force.

The composite cable of the present disclosure may be configured so that the first electric wire, the second electric wire, the twisted pair electric wire, the first wire-shaped filler, the second wire-shaped filler, and third wire-shaped filler are twisted together in a bundled state.

The composite cable of the present disclosure may be configured so that a diameter of the first wire-shaped filler, a diameter of the second wire-shaped filler, and a diameter of the third wire-shaped filler are smaller than a diameter of the first electric wire, a diameter of the second electric wire, and a diameter of the twisted pair electric wire.

The composite cable of the present disclosure may be configured so that the first wire-shaped filler is in contact with the first electric wire and the second electric wire, the second wire-shaped filler is in contact with the second electric wire and the twisted pair electric wire, and the third wire-shaped filler is in contact with the twisted pair electric wire and the first electric wire.

The composite cable of the present disclosure may be configured so that the first wire-shaped filler is in contact with the imaginary circumscribed circle, the second wire-shaped filler is in contact with the imaginary circumscribed circle, and the third wire-shaped filler is in contact with the imaginary circumscribed circle.

The composite cable of the present disclosure may be configured so that the first wire-shaped filler, the second wire-shaped filler, and the third wire-shaped filler do not break when wire breakage occurs in a conductor of the twisted pair electric wire.

The composite cable of the present disclosure may be configured so that one or two selected from the group consisting of the first wire-shaped filler, the second wire-shaped filler, and the third wire-shaped filler are replaced by a single-core third electric wire.

The composite cable of the present disclosure may include a separator layer wound around a circumferential surface of the wire bundle.

The composite cable of the present disclosure may include an inner layer sheath between an inner surface of the outer layer sheath and the wire bundle.

In the composite cable of the present disclosure, the first electric wire and the second electric wire may each be a power line, and the twisted pair electric wire may be formed by twisting two signal wires.

The composite cable of the present disclosure may be configured for use with an electric brake of an automobile.

### DETAILED DESCRIPTION OF EMBODIMENTS OF PRESENT DISCLOSURE

Specific examples of the composite cable of the present disclosure will now be described with reference to the drawings. The present invention is not limited to the illustrated embodiments and intended to be defined by the claims and their equivalents, and all variations within the scope of the claims and their equivalents.

### First Embodiment

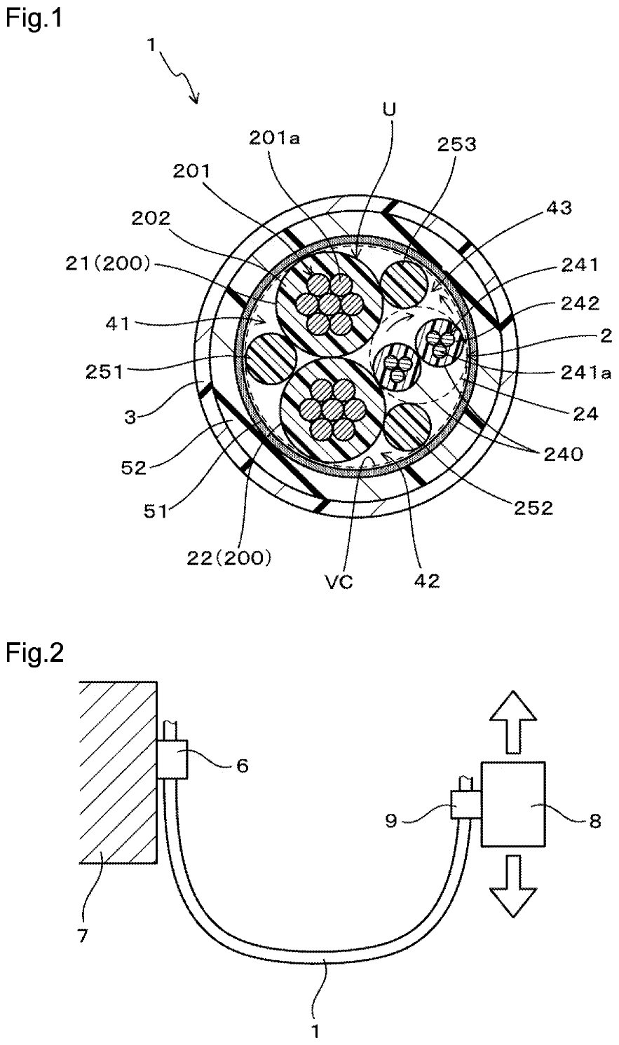

A composite cable of a first embodiment will now be described with reference to FIGS. 1 and 2. As exemplified in FIG. 1, a composite cable 1 of the present embodiment includes a wire bundle 2 and an outer layer sheath 3. In the present embodiment, the wire bundle 2 includes a single-core first electric wire 21, a single-core second electric wire 22, a double-core twisted pair electric wire 24, a first wire-shaped filler 251, a second wire-shaped filler 252, and a third wire-shaped filler 253. The dotted lines in the drawing indicate twisting. Arrows in the vicinity of the dotted lines indicate the twisting direction. The dotted line in the drawing showing a circumscribed circle circumscribing a wire unit U, which will be described later, indicates an imaginary circumscribed circle VC, which will be described later.

The background of the composite cable 1 in accordance with the present embodiment will now be described.

The inventors of the present invention have attempted to uniformly distribute the rigidity of the composite cable 1 in the circumferential direction to improve the bendability of the composite cable 1 and avoid wire breakage of conductors 241 and 201 caused by concentrated bending.

Also, the present inventors have conducted a study on how to remove the outer layer sheath 3 and an inner layer sheath 52. When removing the coating from the cable, a blade is pierced into the cable. If the coating thickness of the composite cable 1 is not uniform and the wire bundle 2 is not circular, the piercing amount of blade in the composite cable 1 will be limited.

Accordingly, the present inventors have provided the composite cable 1 with a uniform coating thickness and formed a circular wire bundle 2 to evenly distribute rigidity in the circumferential direction of the composite cable 1. Further, the present inventors have surrounded and covered the wire bundle 2 with an inner layer sheath 52 and arranged the first wire-shaped filler 251, the second wire-shaped filler 252, and the third wire-shaped filler 253 therein to obtain the composite cable 1 of the first embodiment.

The use of the inner layer sheath 52, the first wire-shaped filler 251, the second wire-shaped filler 252, and the third wire-shaped filler 253 may harden the composite cable 1 and decrease the bendability. Nevertheless, the present inventors have prepared the composite cable 1 and found that the composite cable 1 has a surmounting effect of evenly distributing the rigidity in the circumferential direction.

When the first wire-shaped filler 251, the second wire-shaped filler 252, the third wire-shaped filler 253, and the inner layer sheath 52 are added, the manufacturing process may be complicated and the diameter may be increased. This will deter a person skilled in the art from employing the configuration of the composite cable 1 in accordance with the first embodiment unless there is a reason to do so.

The first electric wire 21 and the second electric wire 22 may each be formed by an insulated electric wire 200. The insulated electric wire 200 includes a conductor 201 and an insulator 202 that covers the circumference of the conductor 201. The conductor 201 may be formed by a stranded conductor including a strand of metal wires 201a. Each of the metal wires 201a may be formed from, for example, copper, a copper alloy, aluminum, or an aluminum alloy. The insulator 202 may be formed from polyethylene, cross-linked polyethylene, or the like. The first electric wire 21 and the second electric wire 22 may have the same diameter or different diameters. In the example shown in FIG. 1, the first electric wire 21 and the second electric wire 22 have the same diameter. Specifically, the first electric wire 21 and the second electric wire 22 may each be a power line.

The twisted pair electric wire 24 may be formed by two insulated electric wires 240 that are twisted helically. Each of the insulated electric wires 240 includes a conductor 241 and an insulator 242 that covers the circumference of the conductor 241. The conductor 241 may be formed by a stranded conductor including a strand of metal wires 241a. Each of the metal wires 241a may be formed from, for example, copper, a copper alloy, aluminum, or an aluminum alloy. The insulator 242 may be formed from polyethylene, cross-linked polyethylene, or the like. The two insulated electric wires 240 of the twisted pair electric wire 24 may have the same diameter or different diameters. In the example shown in FIG. 1, the two insulated electric wires 240 of the twisted pair electric wire 24 have the same diameter. Further, in FIG. 1, the diameter of each of the two insulated electric wires 240 forming the twisted pair electric wire 24 is smaller than the diameter of the first electric wire 21 and the second electric wire 22. Specifically, the twisted pair electric wire 24 may be formed by twisting two signal wires.

The wire bundle 2 includes the first wire-shaped filler 251, the second wire-shaped filler 252, and the third wire-shaped filler 253 that are not electric wires. Each of the first wire-shaped filler 251, the second wire-shaped filler 252, and the third wire-shaped filler 253 is formed to be wire-shaped. Specifically, each of the first wire-shaped filler 251, the second wire-shaped filler 252, and the third wire-shaped filler 253 may be formed to be wire-shaped from an insulating material. The insulating material may be a polymer. Examples of the polymer may include a resin such as polyolefin (polyethylene, polypropylene, or the like), polyester (polyethylene terephthalate or the like), and polyvinyl chloride and rubber. The insulating material may be cross-linked. The first wire-shaped filler 251, the second wire-shaped filler 252, and the third wire-shaped filler 253 may be, for example, cord-like, rod-like, or be fibrous and include filaments or the like formed from the above-described insulating material.

The first wire-shaped filler 251, the second wire-shaped filler 252, and the third wire-shaped filler 253 may be formed from the same material or different materials. In the former case, since there is no need to produce the first wire-shaped filler 251, the second wire-shaped filler 252, and the third wire-shaped filler 253 from different materials, the efficiency of producing of the composite cable 1 will be improved. In the latter case, since the first wire-shaped filler 251, the second wire-shaped filler 252, and the third wire-shaped filler 253 are formed from different materials, the rigidity of the composite cable 1 is easily adjusted in the circumferential direction of the cable.

The first wire-shaped filler 251, the second wire-shaped filler 252, and the third wire-shaped filler 253 may have the same diameter or different diameters. In the former case, since there is no need to produce the first wire-shaped filler 251, the second wire-shaped filler 252, and the third wire-shaped filler 253 with different diameters, the efficiency of producing of the composite cable 1 will be improved. In the latter case, the different diameters of the first wire-shaped filler 251, the second wire-shaped filler 252, and the third wire-shaped filler 253 will facilitate adjustment of the filling amount (filling capability) of a first space 41, a second space 42, and a third space 43, which will be described later. This obtains the composite cable 1 of which the rigidity is readily adjustable in the circumferential direction of the cable. In the example shown in FIG. 1, the first wire-shaped filler 251, the second wire-shaped filler 252, and the third wire-shaped filler 253 are formed from the same material and have the same diameter.

The outer layer sheath 3 covers the wire bundle 2. That is, the outer layer sheath 3 entirely covers the first electric wire 21, the second electric wire 22, the twisted pair electric wire 24, the first wire-shaped filler 251, the second wire-shaped filler 252, and the third wire-shaped filler 253. The outer layer sheath 3 may be formed from polyurethane resin or the like.

In a cross-sectional view (orthogonal to cable axis), the wire bundle 2 includes the wire unit U in which the first electric wire 21, the second electric wire 22, and the twisted pair electric wire 24 are arranged in contact with one another. Thus, in the cross-sectional view of the wire bundle 2, lines connecting the center of the first electric wire 21, the center of the second electric wire 22, and the center of the twisted pair electric wire 24 form a triangle, and the axis of the composite cable 1 is located in the triangle. Further, in the wire bundle 2, when a circumscribed circle circumscribing the wire unit U is referred to as the imaginary circumscribed circle VC, the first wire-shaped filler 251 is disposed in the first space 41 formed between the first electric wire 21, the second electric wire 22, and the imaginary circumscribed circle VC. The imaginary circumscribed circle VC is not limited to a perfect circle and also includes distorted shapes such as an ellipse. Similarly, the second wire-shaped filler 252 is disposed in the second space 42 formed between the second electric wire 22, the twisted pair electric wire 24, and the imaginary circumscribed circle VC. Also, the third wire-shaped filler 253 is disposed in the third space 43 formed between the twisted pair electric wire 24, the first electric wire 21, and the imaginary circumscribed circle VC. The first space 41 is surrounded by part of the surface of the first electric wire 21, part of the surface of the second electric wire 22, and part of the imaginary circumscribed circle VC. The second space 42 is surrounded by part of the surface of the second electric wire 22, part of the surface of the twisted pair electric wire 24, and part of the imaginary circumscribed circle VC. The third space 43 is surrounded by part of the surface of the twisted pair electric wire 24, part of the surface of the first electric wire 21, and part of the imaginary circumscribed circle VC.

The operation and advantages of the composite cable 1 will now be described. The composite cable 1 has the above-described structure. Accordingly, rigidity is evenly distributed in the circumferential direction of the composite cable 1 as compared to a composite cable that has a wire bundle including the first electric wire 21, the second electric wire 22, and the twisted pair electric wire 24 but not a wire-shaped filler. This reduces situations in which the cable bends only in a certain direction. Therefore, the composite cable 1 reduces concentrated bending in a direction in which the rigidity is relatively low when the cable is repetitively bent and easily avoids wire breakage of the conductors 241 and 201.

Further, even when the composite cable 1 is fastened by a crimp of a bracket, the cable shape will be maintained as the first wire-shaped filler 251, the second wire-shaped filler 252, and the third wire-shaped filler 253 deform in the first space 41, the second space 42, and the third space 43, respectively. Thus, the composite cable 1 readily maintains the cable shape and stabilizes the fastening force.

In the composite cable 1, the first electric wire 21, the second electric wire 22, the twisted pair electric wire 24, the first wire-shaped filler 251, the second wire-shaped filler 252, and the third wire-shaped filler 253 can be twisted together in a bundled state. This structure increases rigidity and reduces the stress load applied to the conductors. This also improves resistance to bending and vibration.

The composite cable 1 is configured so that the diameter of each of the first wire-shaped filler 251, the second wire-shaped filler 252, and the third wire-shaped filler 253 is smaller than the diameter (that is, strand diameter) of each of the first electric wire 21, the second electric wire 22, and the twisted pair electric wire 24. This allows the first wire-shaped filler 251, the second wire-shaped filler 252, and the third wire-shaped filler 253 to be readily disposed in the first space 41, the second space 43, and the third space 43, respectively. Thus, the shape of the imaginary circumscribed circle VC basically remains the same and cyclic unevenness that may occur in the cable longitudinal direction may be avoided in the composite cable 1. Further, this structure limits increases in the diameter of the composite cable 1.

In the composite cable 1, the first wire-shaped filler 251 is in contact with the first electric wire 21 and the second electric wire 22, the second wire-shaped filler 252 is in contact with the second electric wire 22 and the twisted pair electric wire 24, and the third wire-shaped filler 253 is in contact with the twisted pair electric wire 24 and the first electric wire 21. This structure limits displacement of the first wire-shaped filler 251, the second wire-shaped filler 252, and the third wire-shaped filler 253 in the first space 41, the second space 42, and the third space 43. Thus, when the cable is fastened by a crimp of a bracket, the cable shape will be evenly deformed. This further stabilizes the fastening force of the composite cable 1. Also, this structure allows the first wire-shaped filler 251, the second wire-shaped filler 252, and the third wire-shaped filler 253 to be located closer to the cable center and improves the eccentricity ratio.

The composite cable 1 can be formed so that the first wire-shaped filler 251 is in contact with the imaginary circumscribed circle VC, the second wire-shaped filler 252 is in contact with the imaginary circumscribed circle VC, and the third wire-shaped filler 253 is in contact with the imaginary circumscribed circle VC. With this structure, a cover (specifically, separator layer 51, described later in the present embodiment), which covers the outer circumferential surface of the wire bundle 2, can be readily supported from the inner side by the first wire-shaped filler 251, the second wire-shaped filler 252, and the third wire-shaped filler 253 that are in point contact with the cover in a cross-sectional view. This structure allows for even deformation of the cable shape when the cable is fastened by a crimp of a bracket. Thus, the composite cable 1 further stabilizes the fastening force and facilitates removal of the outer layer sheath 3 in a subsequent process.

The composite cable 1 may include a separator layer 51 wound around the circumferential surface of the wire bundle 2. This structure hinders adhesion of the various members forming the wire bundle 2 with the outer layer sheath 3 and the inner layer sheath 5, which will be described later. Further, this structure avoids untwisting of the various members forming the wire bundle 2 that are twisted in a bundled state. Specifically, the separator layer 51 may be formed by winding a tape member or the like around the circumferential surface of the wire bundle 2. The material of the separator layer 51 may be, for example, paper or a resin.

The composite cable 1 may include the inner layer sheath 52 between the inner surface of the outer layer sheath 3 and the wire bundle 2. This structure allows unevenness in the surface shape of the wire bundle 2 to be reduced so that the cross-sectional shape of the cable becomes closer to a circle prior to formation of the outer layer sheath 3. This allows the composite cable 1 to have a circular cross section. When the inner layer sheath 52 has a circular contour in a cross-sectional view of the composite cable 1, the advantage described above will be ensured. The inner layer sheath 52 may be formed from polyethylene, cross-linked polyethylene, or the like.

FIG. 1 shows a specific example in which the inner layer sheath 52 covers the separator layer 51, which is wound around the circumferential surface of the wire bundle 2. With this structure, even when the outer surface of the separator layer 51 is uneven in a cross-sectional view, the inner layer sheath 52 allows the cross-sectional shape of the cable to become closer to a circle prior to formation of the outer layer sheath 3. Thus, the composite cable 1 will easily obtain a circular cross section.

The composite cable 1 can be formed so that the first wire-shaped filler 251, the second wire-shaped filler 252, and the third wire-shaped filler 253 do not break when wire breakage occurs in the conductor of the twisted pair electric wire 24. With this structure, the first wire-shaped filler 251, the second wire-shaped filler 252, and the third wire-shaped filler 253 function as tension members. This avoids a situation in which the broken parts of a conductor become disconnected and non-conductive. That is, the first wire-shaped filler 251, the second wire-shaped filler 252, and the third wire-shaped filler 253 allow broken conductor parts to remain in contact with each other. Thus, this structure avoids signal loss, power loss, and the like that would be caused by wire breakage of conductors and improves the reliability of the composite cable 1.

As exemplified in FIG. 2, the composite cable 1 may be used in a state in which one end of the cable is crimped by a crimp (not shown) of a bracket 6 and fastened to a fastening portion 7. Further, the other end of the cable is attached to a vibration portion 8 that vibrates in the vertical direction. This structure sufficiently obtains the above-described advantages. In FIG. 2, the composite cable 1 is bent downwardly into a U-shape, but the composite cable 1 may be bent upwardly into a reverse U-shape.

The composite cable 1 may be for use with an electric brake of an automobile. This structure sufficiently obtains the above-described advantages.

Typically, in an electric brake of an automobile, a motor of a brake caliper is actuated directly or indirectly by a main electronic control unit of the automobile in correspondence with a depressing force applied by a driver to convert the rotational force of the motor to a mechanical pressing force. In this manner, a brake pad is pressed against a brake disc (in case of disc brake) or a brake shoe is pressed against a brake drum (in case of drum brake) to perform braking.

When the composite cable 1 is applied to an electric brake of an automobile, one end of the composite cable 1 may be fastened to a vehicle body or a chassis, and the other end of the composite cable 1 may be attached to the periphery of a wheel that vibrates in the vertical direction. Specifically, the periphery of a wheel may be a position located below a spring of a suspension in an automobile (undercarriage of automobile). The one end of the composite cable 1 may be fastened at one or more positions. Further, the other end of the composite cable 1 may be fastened at one or more positions. The bracket 6 may be used for fastening the composite cable 1, and an attaching bracket 9 or the like may be used for attaching the composite cable 1. The attaching bracket 9 may include a crimp (not shown) for crimping the composite cable 1.

When the composite cable 1 is applied to an electric brake of an automobile, the first electric wire 21 and the second electric wire 22 may be configured to supply electric power for driving a motor included in a brake caliper of the electric brake of the automobile. Further, the twisted pair electric wire 24 may be configured to transmit electric signals related to the rotation speed of a wheel and/or at least transmit electric signals related to control of the motor.

In the example shown in FIG. 1, the first wire-shaped filler 251, the second wire-shaped filler 252, and the third wire-shaped filler 253 are each formed by a single wire-shaped body. The first wire-shaped filler 251, the second wire-shaped filler 252, and the third wire-shaped filler 253 may each be formed by multiple wire-shaped bodies as long as bending is not concentrated in a certain direction when the cable is bent and the fastening force stability is improved when the cable is crimped by the bracket 6 or the attaching bracket 9.

Further, in the composite cable 1, the twisted pair electric wire 24 may be covered by a shield conductor (not shown), a twisted pair electric wire sheath (not shown), or the like. In this case, the shape sustainability of the twisted pair electric wire 24 is improved. Thus, even when the composite cable 1 is vibrated vertically in a bent state, wire breakage resistance of the twisted pair electric wire 24 will be improved.

### Second Embodiment

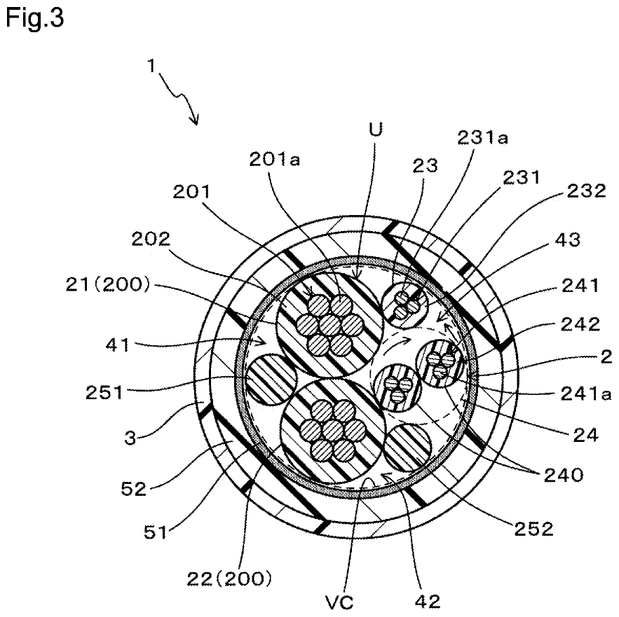

The composite cable 1 of a second embodiment will now be described with reference to FIG. 3. From the second embodiment, same reference numerals are given to those components that are the same as the corresponding components of the above-described embodiment, unless otherwise specified.

In the composite cable 1 of the present embodiment, one or two selected from the group consisting of the first wire-shaped filler 251, the second wire-shaped filler 252, and the third wire-shaped filler 253 in the composite cable 1 of the first embodiment are replaced by a single-core third electric wire. Specifically, the third electric wire 23 may be disposed in the first space 41 instead of the first wire-shaped filler 251. Alternatively, the third electric wire 23 may be disposed in the second space 42 instead of the second wire-shaped filler 252. Alternatively, the third electric wire 23 may be disposed in the third space 43 instead of the third wire-shaped filler 253.

As shown in FIG. 3, the composite cable 1 of the present embodiment is a specific example in which the third wire-shaped filler 253 in the third space 43 of the composite cable 1 in accordance with the first embodiment is replaced by the third electric wire 23.

Even when one or two selected from the group consisting of the first wire-shaped filler 251, the second wire-shaped filler 252, and the third wire-shaped filler 253 are replaced by a single-core third electric wire, the composite cable 1 avoids a situation in which bending is concentrated in a certain direction when the cable is repetitively bent and stabilizes the fastening force when the cable is fastened by a crimp of a bracket. The composite cable 1 of the present embodiment includes a smaller number of wire-shaped fillers than the composite cable 1 of the first embodiment. This lowers the effect of the wire-shaped fillers. Nevertheless, the number of the wires can be easily increased with the composite cable 1 of the present embodiment compared to the composite cable 1 of the first embodiment.

In the present embodiment, the third electric wire 23 may be formed by an insulated electric wire 230. The insulated electric wire 230 includes a conductor 231 and an insulator 232 that covers the circumference of the conductor 231. The conductor 231 may be formed by a stranded conductor including a strand of metal wires 231a. Each of the metal wires 231a may be formed from, for example, copper, a copper alloy, aluminum, or an aluminum alloy. The insulator 232 may be formed from polyethylene, cross-linked polyethylene, or the like. In the example shown in FIG. 3, the third electric wire 23 has a smaller diameter than that of the first electric wire 21 and the second electric wire 22. Further, in FIG. 3, the diameter of the third electric wire 23 is substantially equal to that of each of the two insulated electric wires 240 forming the twisted pair electric wire 24. Alternatively, the diameter of the third electric wire 23 may differ from the diameter of each of the two insulated electric wires 240 forming the twisted pair electric wire 24. Specifically, the third electric wire 23 may be a ground electric wire (also referred to as drain electric wire or earth electric wire) or a signal wire. The remaining structure and advantages are the same as the first embodiment.

### EXPERIMENTAL EXAMPLE

A composite cable having the structure shown in FIG. 1 was prepared. This composite cable is referred to as sample 1. Also, a composite cable having the structure shown in FIG. 3 was prepared. This composite cable is referred to as sample 2. The wire-shaped fillers were each formed from polyethylene. Also, sample 1C of the composite cable was prepared. Sample 1C was analogous to sample 1 of the composite cable 1 except in that the wire-shaped fillers were not included and the wire bundle included only the first electric wire, the second electric wire, and the twisted pair electric wire. That is, in sample 1C of the composite cable 1, the wire-shaped fillers were not disposed in the first space, the second space, and the third space.

The composite cables were bent into a U-shape and one end of each cable was fastened to a fastening portion. Further, the other end of each cable was fastened to a movable portion that can be vibrated in the vertical direction. Such a fastened state simulates a case where one end of the cable is fastened to a vehicle body or a chassis and the other end of the cable is fastened to the periphery of a wheel. In the above-described state, a fastening point of the fastening portion and a center of vertical vibration of the movable portion were set to be located at the same height. Further, the distance between the fastening point of the fastening portion and the center of vertical vibration of the movable portion was set to 100 mm. The length of the cable was set to 200 mm. The movable portion was set to have a vertical movement amount of ±80 mm.

Under the above-described conditions, the movable portion was moved up and down to count the number of times the composite cable was bent until the conductor of the twisted pair electric wire in each sample broke. As a result, the composite cables of samples 1 and 2 were bent more times than the composite cable of sample 1C before the conductor of the twisted pair electric wire broke. Further, in the composite cables of samples 1 and 2, the wire-shaped fillers were not broken when the conductor in the twisted pair electric wire broke. The result indicates that the wire-shaped fillers functioned as tension members in the composite cables of samples 1 and 2.

Also, after the conductor broke in the composite cables of samples 1 and 2 during the experiment, the conduction state of the twisted pair electric wire was checked. It was found that the twisted pair electric wire was still conductive. This is because the wire-shaped fillers functioning as tension members kept the broken parts of the conductor in contact with each other. In the present experimental example, wire breakage did not occur in the conductors of the first electric wire and the second electric wire because each of the first electric wire and the second electric wire had a larger conductor cross-sectional area than each signal wire in the twisted pair electric wire.

The present disclosure is not limited the above-described embodiments and the experimental example, but may be modified without departing from the scope of the invention. The configuration of the embodiments and the experimental example may be combined as needed.

1. A composite cable, comprising:
a wire bundle; and
an outer layer sheath that covers the wire bundle, wherein
the wire bundle includes a single-core first electric wire, a single-core second electric wire, a double-core twisted pair electric wire, a first wire-shaped filler formed to be wire-shaped, a second wire-shaped filler formed to be wire-shaped, and a third wire-shaped filler formed to be wire-shaped,
in a cross-sectional view, the wire bundle includes a wire unit in which the first electric wire, the second electric wire, the twisted pair electric wire are arranged in contact with one another,
in an imaginary circumscribed circle circumscribing the wire unit,
the first wire-shaped filler is disposed in a first space between the first electric wire, the second electric wire, and the imaginary circumscribed circle,
the second wire-shaped filler is disposed in a second space between the second electric wire, the twisted pair electric wire, and the imaginary circumscribed circle, and
the third wire-shaped filler is disposed in a third space between the twisted pair electric wire, the first electric wire, and the imaginary circumscribed circle.

2. The composite cable according to claim 1, wherein the first electric wire, the second electric wire, the twisted pair electric wire, the first wire-shaped filler, the second wire-shaped filler, and third wire-shaped filler are twisted together in a bundled state.

3. The composite cable according to claim 1, wherein a diameter of the first wire-shaped filler, a diameter of the second wire-shaped filler, and a diameter of the third wire-shaped filler are smaller than a diameter of the first electric wire, a diameter of the second electric wire, and a diameter of the twisted pair electric wire.

4. The composite cable according to claim 1, wherein
the first wire-shaped filler is in contact with the first electric wire and the second electric wire,
the second wire-shaped filler is in contact with the second electric wire and the twisted pair electric wire, and
the third wire-shaped filler is in contact with the twisted pair electric wire and the first electric wire.

5. The composite cable according to claim 4, wherein
the first wire-shaped filler is in contact with the imaginary circumscribed circle,
the second wire-shaped filler is in contact with the imaginary circumscribed circle, and
the third wire-shaped filler is in contact with the imaginary circumscribed circle.

6. The composite cable according to claim 1, wherein the first wire-shaped filler, the second wire-shaped filler, and the third wire-shaped filler do not break when wire breakage occurs in a conductor of the twisted pair electric wire.

7. The composite cable according to claim 1, wherein one or two selected from a group consisting of the first wire-shaped filler, the second wire-shaped filler, and the third wire-shaped filler are replaced by a single-core third electric wire.

8. The composite cable according to claim 1, comprising a separator layer wound around a circumferential surface of the wire bundle.

9. The composite cable according to claim 1, comprising an inner layer sheath between an inner surface of the outer layer sheath and the wire bundle.

10. The composite cable according to claim 1, wherein
the first electric wire and the second electric wire are each a power line, and
the twisted pair electric wire is formed by twisting two signal wires.

11. The composite cable according to claim 1, wherein the composite cable is configured for use with an electric brake of an automobile.
